(19) United States
(12) Patent Application Publication
(10) Pub. No.: US 2009/0217890 A1
(43) Pub. Date: Sep. 3, 2009

(54) Bendah rotary cycle internal combustion engine and air compressor

(76) Inventor: Morris Bendah, San Ramon, CA (US)

Correspondence Address: MORRIS BENDAH, 2750 Merced Street, San Leandro, CA, 94577, US

(21) Appl. No.: 12/378,309

(22) Filed: Feb. 12, 2009

Related U.S. Application Data
(63) Continuation-in-part of application No. 61/028,036, filed on Feb. 12, 2008.

(51) Int. Cl. F02B 59/00; F02B 75/06; F02B 25/18

(52) U.S. Cl. 123/42; 123/192.2; 123/65 R

(57) ABSTRACT

The present invention generally relates to a rotary engine and, more particularly, to a rotary engine that, by using cylinder wedge geometry improves output efficiency, and decreases fuel consumption, and at the same time is easy to manufacture, contains fewer parts, uses conventional sealing techniques and has the flexibility to increase or decrease the number of cylinders and rotors to improve the performance of the rotary engine. Also, by utilizing the same mechanism of cylinder wedge geometry, to produce a reliable and efficient air compressor or compressed air motor

### RELATED APPLICATIONS

The present application is a continuation-in-part application of U.S. provisional patent application, Ser. No. 61/028,036, filed Feb. 12, 2009, included by reference herein and for which benefit of the priority date is hereby claimed.

### FIELD OF THE INVENTION

The present invention relates to internal combustion engines and, more particularly, to rotary engines, rotary air compressors and rotary compressed air motors.

### BACKGROUND OF THE INVENTION

Ever since the industrial age promised portable power by use of internal combustion engines, there has been a need for an efficient, clean burning, less complicated engine. This need has never been more important since the impact of pollution, fuel shortages and related increased pricing is becoming more pronounced. The use of fuel and resulting pollution, can be most reduced by automobiles being more efficient. Although there have been many improvements to the conventional reciprocating engine, it has also become more complicated and expensive to manufacture. And still after more than a hundred years, works on the same basic inferior principle of a crankshaft. Most large air compressors also work on the same principle.

FIG. 1 shows a conventional reciprocating engine that uses a confined space for sequentially performing the four cycles of intake 26, compression 28, combustion 30, and exhaust 32, where the crank 14 inside the engine generates the rotational output to the flywheel 24 and the driveshaft 80. The theory behind the traditional reciprocating internal combustion engine has been widely applied in our daily lives for all kinds of land, sea, and air transportation, as well as power generating apparatus for agricultural, manufacturing, and military use. Even though the reciprocating engine is broadly accepted and used, it does not mean that the performance has reached perfection. In fact, there are the following bottlenecks in the reciprocating engine regardless whether it is of 2-stroke or 4-stroke design:

(1) Output power cannot be easily increased: reciprocating engine relies on a crank 14 to convert the reciprocating motion of the piston 10 and connecting rod 12 into a rotational motion which is then coupled to an external driving system. The conversion from the reciprocating motion into the rotational motion causes a loss in the output efficiency, which is unavoidable due to structural limitations.

(2) Structure and manufacturing are complex: the output efficiency of the reciprocating engine is highly related to the precision in the manufacture of the crank, wherein the precision of the crankshaft 14 and the crank pin needs to be extremely high. If there is any error in the level of precision, the conversion from reciprocating output to rotational output will be greatly decreased. Moreover, in a four-cylinder reciprocating engine, the internal parts add up to forty linked parts for operation which results in a high manufacturing cost.

(3) Torque-increase causes fuel consumption to increase: a reciprocating engine can increase the stroke, that is to increase the distance between the connecting rod and the crank, to raise torque. If the stroke is increased, the bore of the cylinder also needs to be increased; therefore, fuel consumption is greatly increased, so an increase in torque and a decrease in fuel consumption cannot be achieved simultaneously.

(4) Increase of the number of cylinders is limited: if the number of cylinders is increased to raise the horsepower of the reciprocating engine, the engine overall size is unavoidably increased. Regardless of the configuration of the cylinders, such as straight, boxer, and slant or the type of configuration V, W, and H, the engine size always increases significantly when cylinders are added.

(5) high-rpm causes wear: when the reciprocating engine revolves over 2000 rpm, such high-rpm reciprocating action will cause the piston to experience an extremely high amount of wear, which, at the same time generates a lot of heat, increasing damage to parts and decreasing the lifespan of the engine. As a result, fuel consumption of the engine increases over time.

In order to solve problem (1) of reciprocating engine regarding power output, a German engineer Felix Wankel invented the Wankel rotary engine, which is illustrated in FIG. 2. An arciform triangular rotor 52 is held within a rotor holding bore, which replaces the cylinder 11 and the piston 10 of the reciprocating engine. The conformance to a peri-trochoidal profile is driven by the requirement that all three bearing points (apex seals 46) of the Wankel rotor remain in constant contact with the inner surface of the engine. The rotor rotates in a planetary motion through the engaging of a rotor gear 54 on the rotor with a gear 50 on an output shaft 56. The interplay of the arciform triangular rotor 52 within the rotor holding bore creates three chambers therein. Under planetary motion of the rotor, the chambers outside of the rotor vary their capacities to perform the four cycles of intake (suction) 26, compression 28, combustion (expansion) 30, and exhaust 32. The output of the Wankel engine is directly connected to the arciform triangular rotor without the need of motion type conversion. The output of the Wankel engine is twice that of the reciprocating engine, and the overall number of components of the Wankel engine is greatly reduced; therefore, from the market launch in 1958, it caused a great shock in the industry. In the era of the 60s, when power was most sought after, the high output rotary engine was put on sports cars, breaking speed records for sports cars, and the rotary engine seemed poised to take over the traditional reciprocating engine.

Although the Wankel engine improved problem (1) of the reciprocating engine, it failed to successfully solve problems (2), (3), and (4). Furthermore, the path of the arciform triangular rotor is not smooth, so at high-rpm, wear at the tips of the rotor causes the exhaust cavity immediately following the ignition point to rapidly enlarge. This causes a significant portion of the gas pressure to be lost to expansion within the enlarging cavity, instead of being converted into useable torque. The problem of power decreasing and fuel consumption increasing becomes more significant as the engine runs more, and, for about every 30,000 miles, the engine needs rebuilding or replacement. This disadvantage proved fatal for the Wankel engine, resulting in the higher carbon monoxide exhaust levels and fuel consumption. The geometry of the Wankel engine, i.e., a peri-trochoidal section, makes it difficult to improve the combustibility of the combustion phase to decrease the exhaust quantity of unburned gases. Although the number of parts of the Wankel engine is much less than a conventional engine, the precision of the inner gear and the outer gear of the arciform triangular rotor has to be extremely high, offsetting the cost-savings generally associated with having fewer parts. Furthermore, the arciform triangular rotor is the part that undergoes the most wear in the engine, and, if there is a problem on a Wankel engine, the whole unit is usually replaced, which reduces practicality. The Wankel engine overcomes some of the limitations of the reciprocating engine, but possesses other disadvantages not found in generic reciprocating engines; therefore, market acceptance has not been as rapid as expected. Beginning with the energy shortage of 1973, vehicle engine research has shifted focus from increasing power to the twin goals of decreasing exhaust emissions and fuel consumption. The shortcomings of the Wankel engine rapidly became apparent and most of the car manufacturers canceled development of the Wankel engine and returned to designs employing the reciprocating engines. Among all the car manufacturers, only Mazda continued the use of Wankel engine and kept making performance modifications. Mazda launched the RX7 model in 1999 with the use of modern lubricants and ceramic material for the triangular tips to lower the wearing problem of the Wankel engine. However, the use of this material greatly increases the manufacturing cost. Any novel industrial product must possess advantages and performance that are not found in prior art. Moreover, the setup of the production equipment and production line cannot be too expensive compared to prior art, otherwise existing manufacturers will not replace the existing product line and business prospects. Possession solely of technical performance is generally not enough for a new design to change the percentage of market share away from conventional technology. Performance has to be combined with ease of manufacturing and low cost to attract manufacturers to invest in or replace production lines. On inspection of the history of the Wankel engine, it can be seen that the difficulty of manufacturing the arciform triangular rotor and the requirement for entirely new equipment to manufacture such a rotary engine caused the Wankel engine to fail to attract manufacturers. In summary, new designs tend to introduce new problems; therefore, advantages must significantly out-weigh disadvantages in order for the new design to take hold. The focus of current engine research is how to design a simple and low cost engine which has higher output than the conventional reciprocating engine while at the same time lowers wear and fuel consumption, increases torque without the expense of fuel consumption, and does not increase engine size significantly with the addition of cylinders.

### SUMMARY OF THE INVENTION

To solve many of the problems with current solutions, this invention uses cylinder wedge geometry and takes advantage of some unique discovered properties. Therefore in this invention, there is provided a stationary cylinder, wherein around the center of which, the surface has an intake aperture, exhaust aperture, and ignition aperture (for providing combustion); then at one end of the cylinder, a rotor with a cylinder wedge shape, which is coupled to the driveshaft; at the other end of the cylinder is a reciprocating piston with a cylinder wedge shape such that when the rotor wedge rotates, the piston wedge reciprocates (by way of a sinusoidal cam) so that the two almost touch each other at only one point throughout the revolution. With two cylinders inline, only one reciprocating piston is used, each end of which has a cylinder wedge shape. In this opposing cylinder configuration, the power revolution of one cylinder pushes the reciprocating piston into the compression revolution of the opposing cylinder. The cavity formed in the cylinder between the rotor wedge and the piston wedge is the combustion chamber. When the tip of the rotor cylinder wedge touches the tip of the piston cylinder wedge, the size of the cavity is at its maximum; this is the beginning of the compression cycle. One half of a rotation later is the combustion cycle. Cylinders back to back, such that there are two rotors and one piston in-line, are the most efficient in that one piston's movement is utilized by two rotors and two combustion chambers. The piston's movement is one quarter of the movement per combustion chamber as compared to a typical oscillating internal combustion engine. Additionally the cylinders can be arranged radially around one driveshaft. Whether all the cylinders are arranged in-line such as a long narrow engine or radially around a driveshaft, the cylinders are exposed sufficiently to allow air cooling of the engine. This option is important in saving weight for airplane engine applications, increasing power to weight ratios. The combination of inline and radial cylinder additions make this engine infinitely and modularly expandable for any size or shape needed. The gas fluid dynamics that exist naturally by the rotational movement of one cylinder wedge against another provides extra mixing efficiency to the air and fuel so that it can burn more completely and cleanly minimizing polluting emissions. Because of the high compression possible with this engine, a diesel cycle (either two cycle or four cycle) can also be utilized delivering even more power for its weight. Additionally, the combustion chamber changes in size geometrically during the beginning of the expansion cycle utilizing more work energy and increasing torque. This same high compression feature of this engine makes it a simple but efficient air compressor or compressed air motor. The angle of the cylinder wedges can be varied when manufactured to change the performance characteristics of this engine; a flatter angle for more speed and less compression and a steeper angle for more torque and higher compression. Other than just the simple angle of the wedge, changes to the shape of the wedge would be made to facilitate even more efficient fluid dynamics of gasses and change performance characteristics for different uses. FIG. 11 shows the comparison of volume changes in the combustion chamber in this invented engine compared to a piston and cylinder in a conventional reciprocating engine. With a 25 degree wedge 65% of the expansion is done in the first 50% of the power cycle, which is when the expanded gas is hottest and most powerful. This is a 30% increase in efficiency alone.

In summary, the cylinder wedge rotor, the cylinder wedge piston, the stationary cylinder, the cam for moving the reciprocating piston, and the driving system and gears of the present invention can solve most of the problems experienced by rotary engines in the prior art. Besides improving the output efficiency of the rotary engine, the number of parts is reduced and the complexity of manufacturing and structure is reduced. A special feature of the present invention is the use of a rotor and reciprocating piston to take advantage of the dynamic geometry of cylinder wedges. Although the piston does not drive the engine, it enhances the rotary and compression properties of the engine. This special feature allows flexibly in changing the angle of the cylinder wedges to effect better performance for various tasks. For example, an engine that is to be used only as a single speed generator would have wedges at different angles than an engine used in a motor vehicle that would need better acceleration performance or higher torque at lower speeds. Another special feature of this engine is that it is easily and modularly capable of being expanded by adding cylinders, either in-line or axially. All cylinders would share a common driveshaft. Some cylinders can be turned off by use of a clutch mechanism on the rotor or driveshaft if they are in line, further increasing the engine's efficiency. When this is done on conventional piston engines and many rotary engines, the engine must “drag” these dead cylinders through the compression cycles minimizing any fuel savings. A further special feature of this engine is the simplicity and small number of parts involved including using a well known and tested method of piston rings for sealing the combustion chamber rather than problematic valves, vanes and linear edges which are difficult to seal and wear out quickly. The design of the seal guides and lubricating oil device provides the present invention with sealing, cooling, and lubricating. Finally, the cylinder wedge configuration is a very efficient compressor (FIG. 12) that can generate very high pressure due to the leverage action of the collapsing cylinder wedge space; this same action, reversed, produces a strong pneumatic motor that can also be miniaturized. Compressor-motors such as these can both propel a compressed air car and also produce compressed air in a regenerative braking configuration.

It is therefore an advantage of the invention to provide a high output rotary engine.

It is another advantage of the advantage to provide a rotary engine that is simple with few parts and low-cost to manufacture.

It is another advantage of the invention to provide a rotary engine that utilizes cylinder wedge geometry

It is another advantage of the invention to provide a rotary engine that can utilize well proven and ordinary seals and bearings minimizing wear while rotating.

It is another advantage of the invention to provide a rotary engine that does not increase fuel consumption while increasing the torque of the rotary engine.

It is another advantage of the invention to provide a rotary engine that has a flexible engine size and shape dependant on the number of cylinders and their arrangement in-line or radially.

It is another advantage of the invention to provide a rotary engine that decreases fuel consumption by being efficient and being able to turn off cylinders.

It is another advantage of the invention to provide a rotary engine that provides good lubrication in a two cycle configuration without increasing emissions

It is another advantage of the invention to provide a rotary engine that is efficiently air-cooled.

It is another advantage of the invention to provide a rotary engine that has a geometrically efficient combustion chamber.

It is another advantage of the invention to provide a rotary engine that has high enough compression to use a Diesel cycle in either a two cycle or four cycle configuration.

It is another advantage of the invention to provide a rotary engine that can be used as an efficient air compressor or compressed air (pneumatic) motor.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a section view of a reciprocating internal combustion engine;

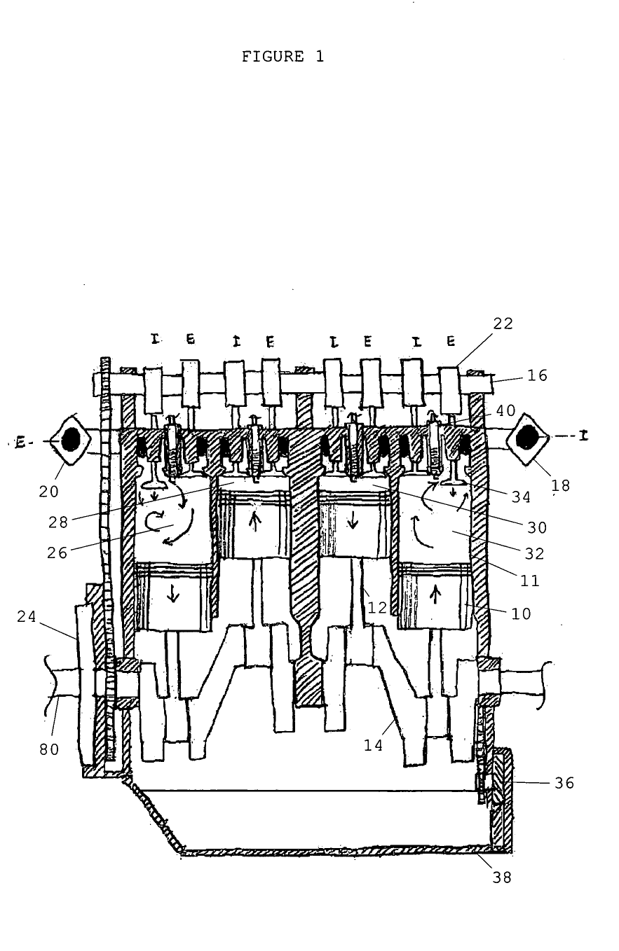

FIG. 2 is a section view of a rotary wankel type internal combustion engine;

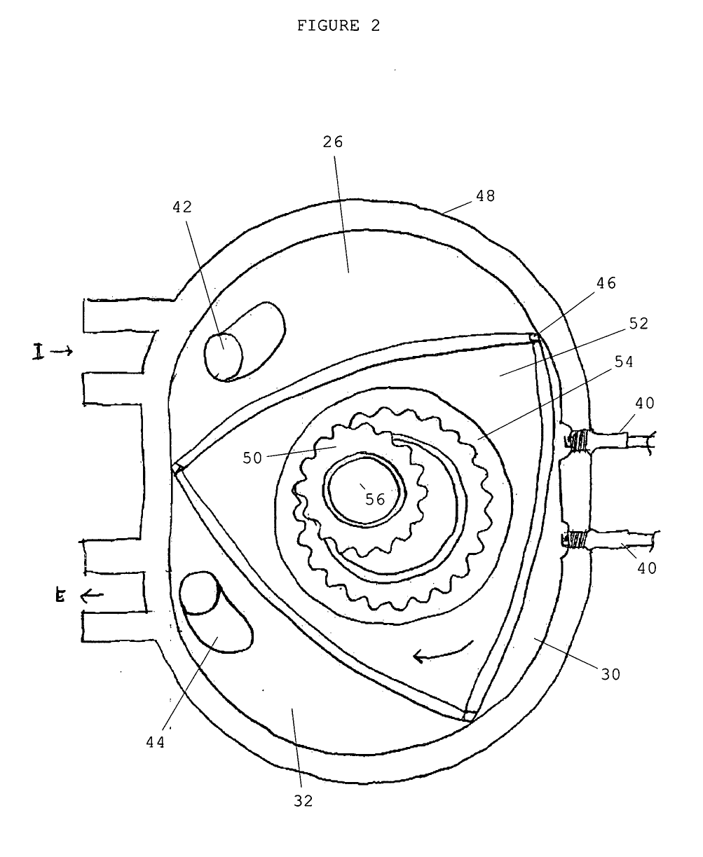

FIG. 3 is a perspective view of the steps of movement in cylinder;

FIG. 4 is a section view of a two cycle four cylinder bendah rotary engine;

FIG. 5 is a section view of a four cycle, four cylinder bendah rotary engine showing power and compression cycles;

FIG. 6 is a section view of a four cycle, four cylinder bendah rotary engine showing intake and exhaust cycles;

FIG. 7 is a side view of a four cycle four cylinder bendah rotary engine;

FIG. 8 is a bottom and side view of a cylinder wedge rotor;

FIG. 9 is a separated side and rear view of a cylinder wedge rotor;

FIG. 10 is a side and front view of a cylinder wedge rotor combustion chamber variability and valve positioning variability;

FIG. 11 is a graph view of a relationship between volume of combustion chamber and degrees of rotation of the rotor in the bendah cylinder wedge engine or crankshaft in a reciprocating engine; and

FIG. 12 is a section view of an air compressor or pneumatic motor using bendah rotary engine methodology.

For purposes of clarity and brevity, like elements and components will bear the same designations and numbering throughout the Figures.

### DESCRIPTION OF THE PREFERRED EMBODIMENT

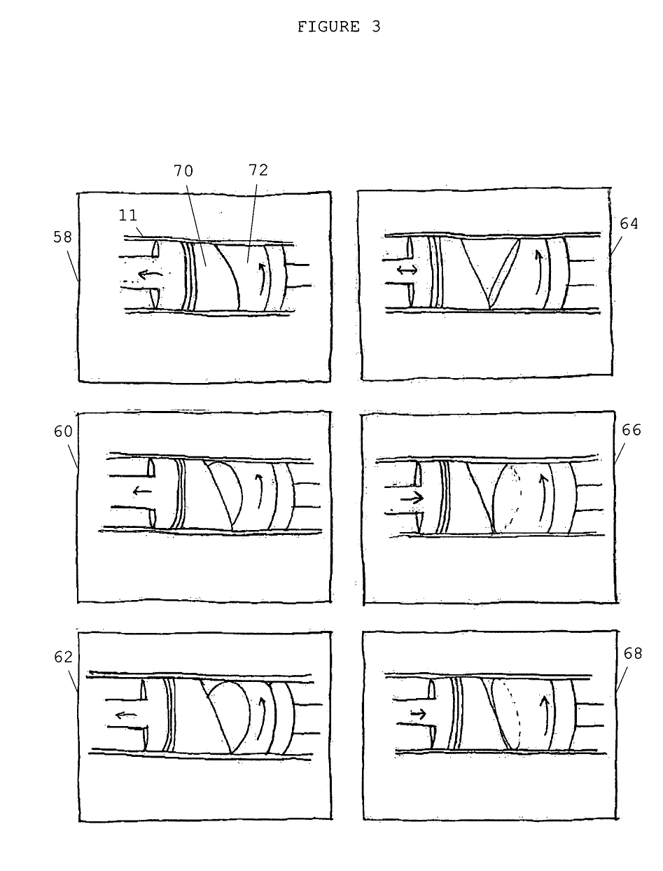

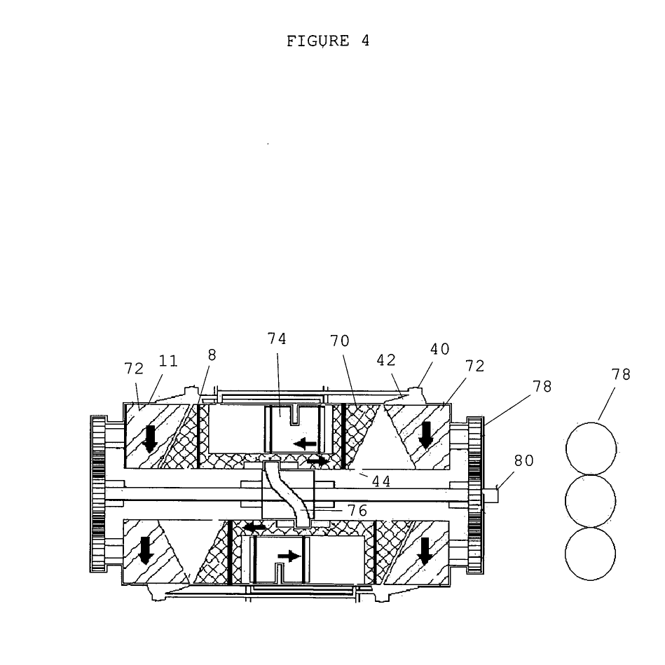

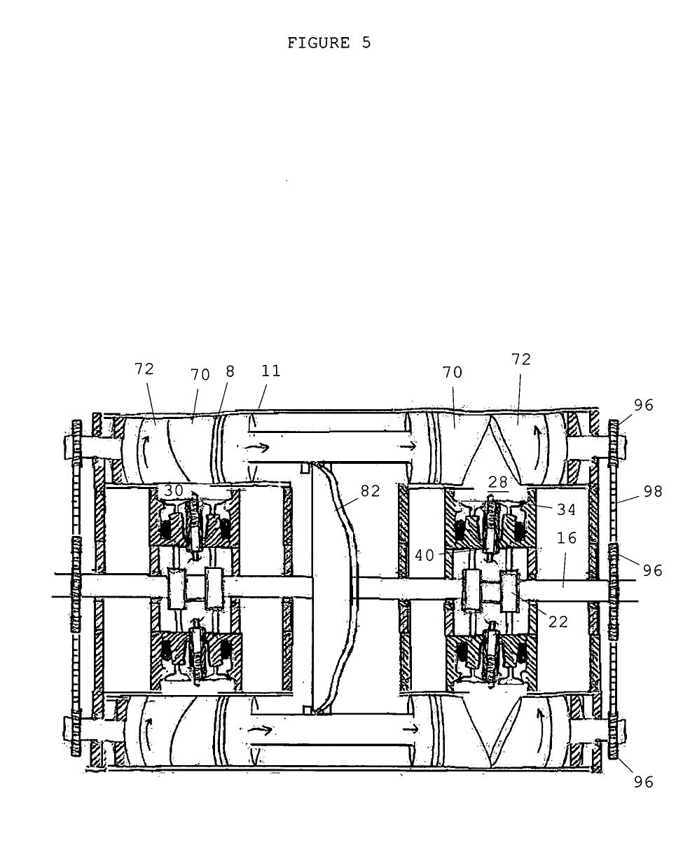

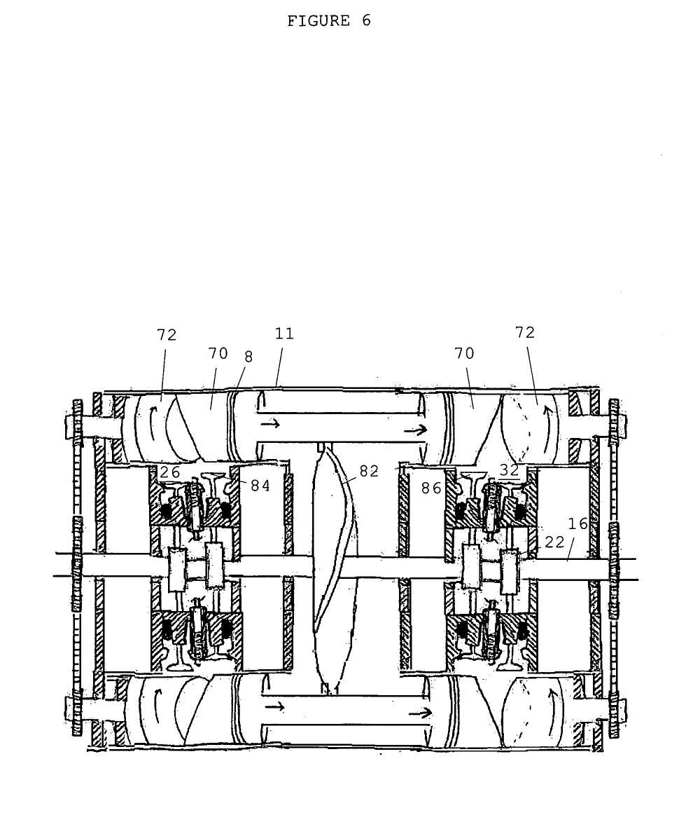

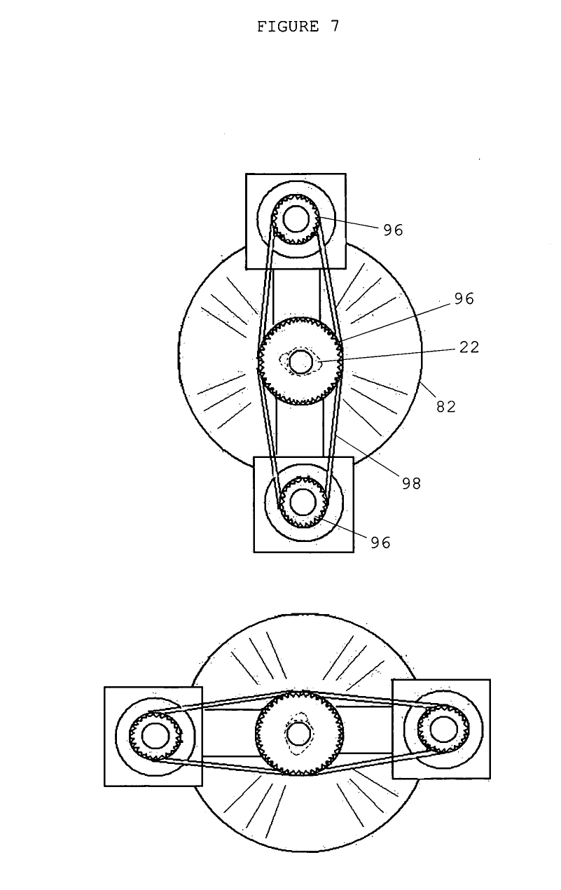

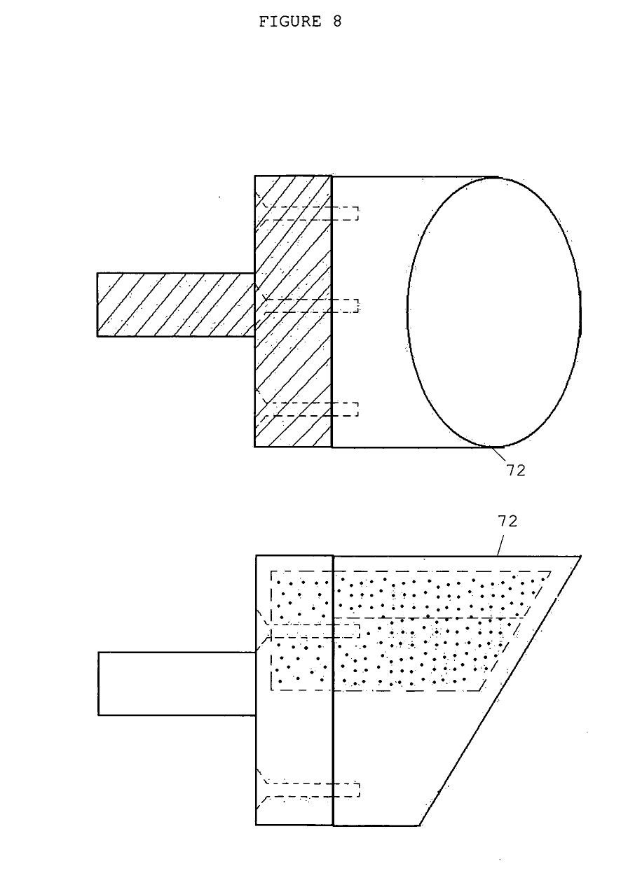

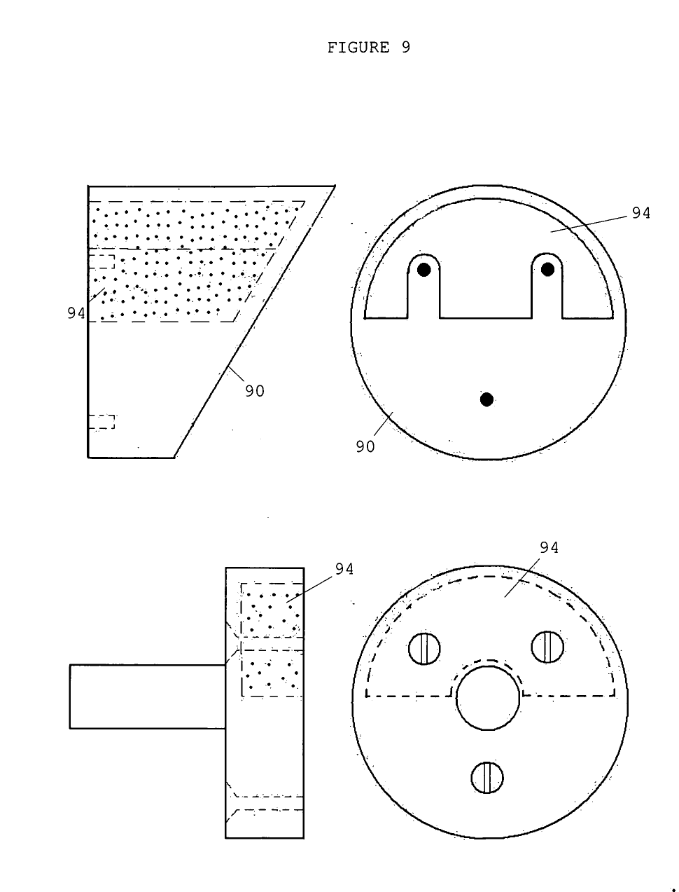

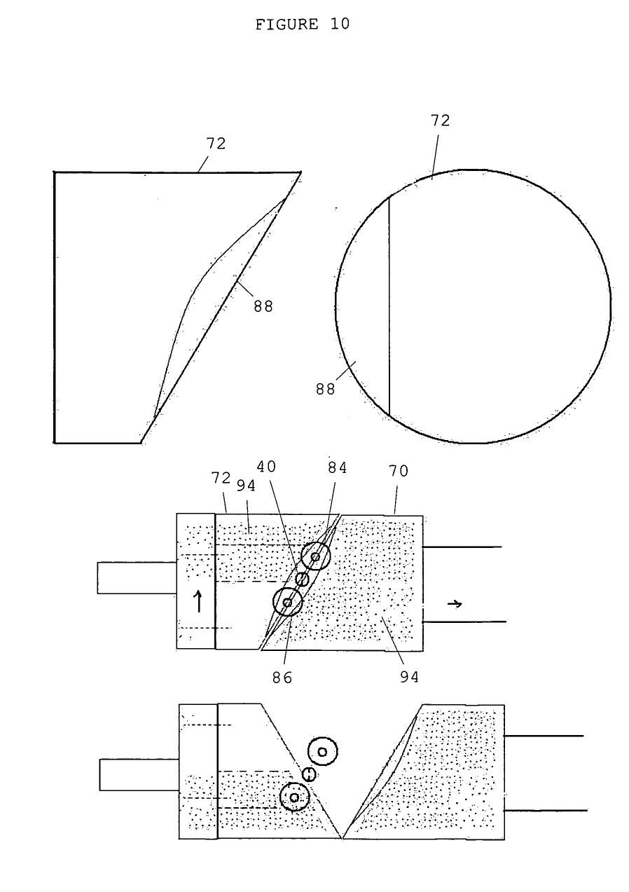

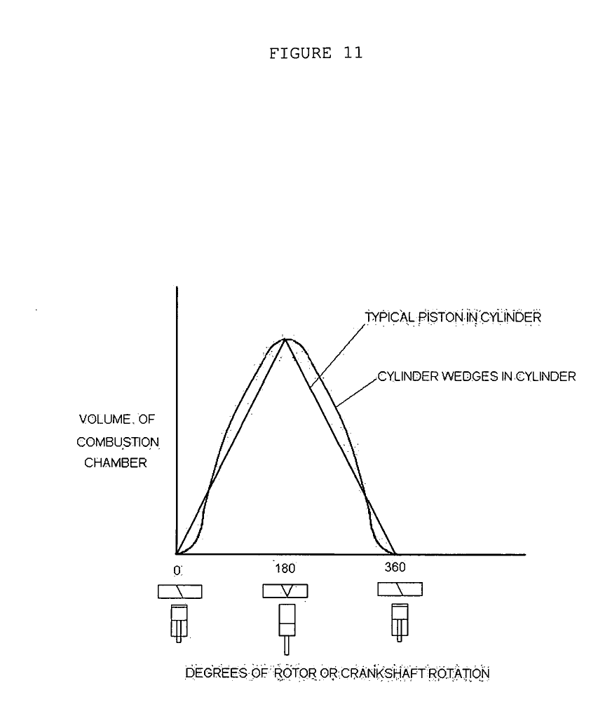

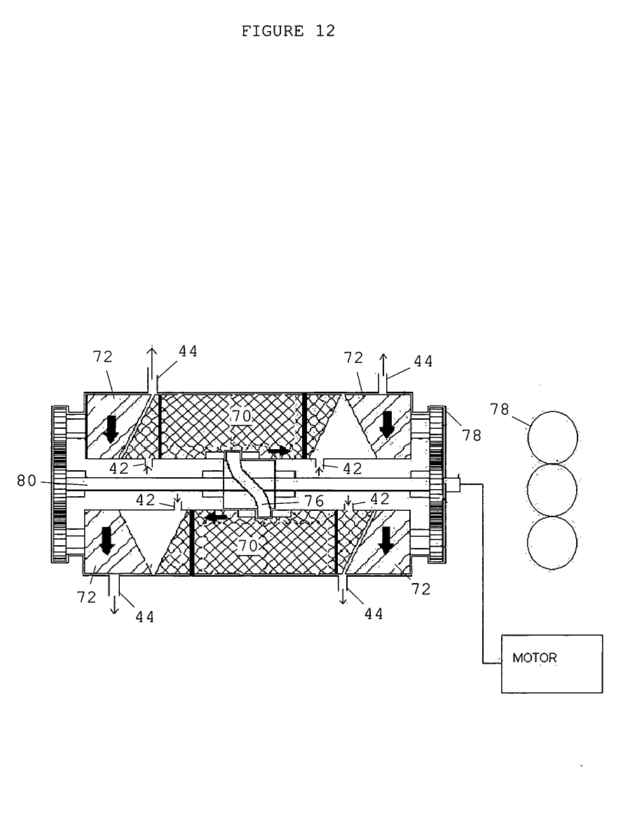

In accordance with the present invention, there is provided a stationary cylinder sleeve 11, wherein around the center of which, the surface has an intake 18 aperture, exhaust 20 aperture, and ignition aperture (for providing combustion); then at one end of the cylinder, a rotor 52 with a cylinder wedge shape, which is coupled to the driveshaft 80; at the other end of the cylinder is a reciprocating piston 10 with a cylinder wedge shape such that when the rotor 52 wedge rotates, the piston 10 wedge reciprocates so that the two almost touch each other at only one point throughout the revolution. With two rotor cylinder wedge 72 inline, only one reciprocating piston 10 is used, each end of which has a cylinder wedge shape (twin piston cylinder wedge 70). In this opposing cylinder configuration, the power revolution of one cylinder pushes the reciprocating piston 10 into the compression revolution of the opposing cylinder. The cavity formed in the cylinder between the rotor cylinder wedge 72 and the piston cylinder wedge 70 is the combustion chamber. When the tip of the rotor cylinder wedge 72 touches the tip of the piston cylinder wedge 70, the size of the cavity is at its maximum; this is the beginning of the compression cycle 28. One half of a rotation later is the combustion cycle. FIG. 3 is a perspective view of the steps of movement in cylinder sleeve 11 showing six sixth of revolution of a piston cylinder wedge 70 interacting with a piston cylinder wedge 70. Zero or six sixth revolution 58 shows the two wedges as close as they can be to one another with the combustion chamber at its smallest which would be the beginning of the intake cycle 26 or the beginning of the power cycle 30 of a four cycle engine. One sixth revolution 60 and two sixth revolution 62 shows the change in the shape and size of the combustion chamber during the revolution. The complex shape of the combustion chamber as it is expanding, turbulently mixes the incoming fuel air mixture for more complete combustion. Also the volume increase is not directly related to the revolution of the rotor cylinder wedge 72, it is geometrically related which increases velocity of the airflow (see FIG. 11) for the intake cycle 26 and more efficiently uses the energy produced by the power cycle 30 to produce more torque. Three sixth revolution 64 (one half of a revolution) is where the combustion chamber is at its largest and the tips of the cylinder wedges are barely touching each other. This would be the beginning of the compression cycle 28 or the beginning of the exhaust cycle 32 in a four cycle engine. Four sixth revolution 66 and five sixth revolution 68 would coincide with the exhaust cycle 32 or the compression cycle 28. Here the volume change is slow at first and then accelerates at the end. This property increases the velocity of the flow of exhaust 20 gasses just before the exhaust valve 86 closes and increases compression just before ignition by the sparkplug 40. When used in two cycle configuration, this increases efficiency of removing exhaust 20 gasses. The engine can be utilized as a four cycle or two cycle configuration based almost entirely on when the exhaust port 44 and intake port 42 are ported or valved and the sinusoidal cam being used. In the two cycle configuration, there already exists the fluid dynamics in the gas flow to facilitate efficient removal of exhaust 20 gases because of the rotational movement of the rotor cylinder wedge 72. Additionally, the piston cylinder wedge 70 can be an efficient fuel pump in the two cycle configuration, similar to the fuel system accorded by the bottom of a piston 10 in a conventional two cycle internal combustion engine. The big difference is that oil in the fuel may not be necessary since the rotor cylinder wedge 72 and the piston cylinder wedge 70 may be separately lubricated (since the piston 10 does not have a connecting rod 12 attached to it). FIG. 4 is a section view of a two cycle four cylinder Bendah rotary engine. If used in a 2 cylinder 2 cycle configuration, a stationary piston 74 is inside the double sided piston cylinder wedge 70 to perform the same function. An air compressor is just the two cycle configuration without the stationary piston 74 working in reverse. FIG. 5 is a section view of a four cycle, four cylinder Bendah rotary engine showing power cycle 30 and compression cycle 28. FIG. 6 is a section view of a four cycle, four cylinder Bendah rotary engine showing intake cycle 26 and exhaust cycle 32. In a four cycle configuration this engine is a high compression efficient engine that benefits from the simplicity of a rotor cylinder wedge 72 (rather than a heavy complicated crankshaft 14) but using conventional seals, oil bearings and piston rings 8. If conventional valves are used then the driveshaft 80, camshaft 16 and the sinusoidal cam necessary for moving the reciprocating piston 10 are integral and manufactures as one piece. The two cycle sinusoidal cam 76 (FIG. 4) is different from the four cycle sinusoidal cam 82 (FIGS. 5 and 6). The two cycle sinusoidal cam 76 causes the piston cylinder wedge 70 to reciprocate back and forth in one revolution and the camshaft 16 that it is attached to is connected by drive gears 78 to the rotor 52 cylinder wedges by a one to one ratio, so that one revolution of the sinusoidal cam equals one revolution of the rotor cylinder wedge 72. The four cycle sinusoidal cam 82 causes the piston cylinder wedge 70 to reciprocate back and forth twice in one revolution and the camshaft 16 that it is attached to is connected by chain sprocket 96 and timing chain 98 to the rotor cylinder wedge 72 by a one to two ratio (see FIG. 7), so that one revolution of the sinusoidal cam equals two revolutions of the rotor cylinder wedge 72. This speed accommodates the synchronizing of the valve cam 22 on the same driveshaft 80. The intake valve 84 and exhaust valve 86 is actuated by the valve cam 22 on the integral driveshaft 80 with sinusoidal cam shaft. The rotary engine of the present invention is further coupled to a lubrication oil tank for pumping lubricating oil to the rotor 52 bearing, piston 10 cylinder walls and the reciprocating cam. During rotation of the rotor 52, centrifugal force will pump the lubricating oil onto the surface of the stationary cylinder where the reciprocating cylinder wedge piston 10 is, to the main rotor 52 bearing and to the cam the to cool and lubricate the internal parts of the rotary engine. Cylinders back to back, such that there are two rotor cylinder wedge 72 and one piston cylinder wedge 70 in-line, are the most efficient in that one piston's movement is utilized by two rotors and two combustion chambers. Additionally the cylinders can be arranged radially around one driveshaft 80. Whether all the cylinders are arranged in-line such as a long narrow engine or radially around a driveshaft 80, the cylinders are exposed sufficiently to allow air cooling of the engine. This option is important in saving weight for airplane engine applications, increasing power to weight ratios. The combination of inline and radial cylinder additions make this engine infinitely and modularly expandable for any size or shape needed. The gas fluid dynamics that exist naturally by the rotational movement of one cylinder wedge against another provides extra mixing efficiency to the air and fuel so that it can burn more completely and cleanly minimizing polluting emissions. Because of the high compression possible with this engine, a diesel cycle (either two cycle or four cycle) can also be utilized delivering even more power for its weight. Additionally, the combustion chamber changes in size geometrically during the beginning of the expansion cycle utilizing more work energy and increasing torque (see FIG. 11). This same high compression feature of this engine makes it a simple but efficient air compressor or compressed air motor (see FIG. 12, a sectional view of an air compressor or pneumatic motor (working backwards)). The angle of the cylinder wedges can be varied when manufactured to change the performance characteristics of this engine; a flatter angle for more speed and less compression and a steeper angle for more torque and higher compression. Other than just the simple angle of the wedge, changes to the shape of the wedge would be made to facilitate even more efficient fluid dynamics of gasses and change performance characteristics for different uses. Because of the complex shape of two cylinder wedges against each other, trial and error is needed to find useful alterations. FIG. 10 shows a bevel 88 in the side of the cylinder wedge portion 90 to enhance flow in the combustion chamber if the valves are diagonally situated in line with the wedge position at zero or six sixth revolution 58. The bevel 88 also enhances the movement of the wedges against each other, requiring a less complex sinusoidal cam. FIG. 8 and FIG. 9 illustrate the construction of the rotor cylinder wedge 72 from two pieces, the rotor portion 92 and the wedge portion 90. In order to make this rotor cylinder wedge 72 rotationally balanced, the wedge portion 90 needs to have a pocket 94 (so that it is hollow at the thick side of the wedge and preferably made from a light metal such as aluminum. The rotor portion 92 preferably made from steel must also be drilled or pocketed where it attaches to the wedge portion 90 so that weight of the fastened together parts are rotationally balanced.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A bendah rotary cycle internal combustion engine and air compressor for the efficient burning of fuel to produce work energy in the form of an internal combustion engine and, to efficiently compress air in the form of an air compressor, and to efficiently produce work energy from compressed air in the form of a compressed air motor, comprising:
means for oscillating to accommodate changes in size to the combustion chamber by the rotor cylinder wedge;
means for rotating to provide suction intake when intake valve is open, rotating to provide compression of air/fuel mixture when intake valve and exhaust valve is closed, rotating in response to expanding gas from combustion cycle mixture ignited, and rotating to push exhaust out of chamber when exhaust valve is open;
means for compressing air/fuel mixture into combustion chamber for two cycle engine operation, internally placed to said means for oscillating to accommodate changes in size to the combustion chamber by the rotor cylinder wedge;
means for oscillating piston cylinder wedge to accommodate changing combustion chamber size in two cycle engine or air compressor, reciprocally coupled to said means for oscillating to accommodate changes in size to the combustion chamber by the rotor cylinder wedge;
means for oscillating piston cylinder wedge to accommodate changing combustion chamber size in four cycle engine, reciprocally coupled to said means for oscillating to accommodate changes in size to the combustion chamber by the rotor cylinder wedge;
means for enhancing the performance of the combustion chamber beneath valves and spark plug;
means for attaching to rotor to form balanced rotor cylinder wedge;
means for attaching to wedge portion to form balanced rotor cylinder wedge, rigidly fastened to said means for attaching to rotor to form balanced rotor cylinder wedge; and
means for producing a rotationally balanced rotor cylinder wedge.

2. The bendah rotary cycle internal combustion engine and air compressor in accordance with claim 1, wherein said means for oscillating to accommodate changes in size to the combustion chamber by the rotor cylinder wedge comprises a has angled wedge surface towards combustion chamber, has oil ring, has two compression rings, connected to another piston cylinder wedge of opposite direction, hollow pocketed to be lightweight piston cylinder wedge.

3. The bendah rotary cycle internal combustion engine and air compressor in accordance with claim 1, wherein said means for rotating to provide suction intake when intake valve is open, rotating to provide compression of air/fuel mixture when intake valve and exhaust valve is closed, rotating in response to expanding gas from combustion cycle mixture ignited, and rotating to push exhaust out of chamber when exhaust valve is open comprises a has angled surface towards combustion chamber, light wedge portion and heavy rotor portion, hollow on large side, rotationally balanced rotor cylinder wedge.

4. The bendah rotary cycle internal combustion engine and air compressor in accordance with claim 1, wherein said means for compressing air/fuel mixture into combustion chamber for two cycle engine operation comprises a for two stroke operation, has two compression rings stationary piston.

5. The bendah rotary cycle internal combustion engine and air compressor in accordance with claim 1, wherein said means for oscillating piston cylinder wedge to accommodate changing combustion chamber size in two cycle engine or air compressor comprises an one rotation provides for one cycle of oscillation of piston cylinder wedge, revolves at same speed as rotor cylinder wedge, integral with driveshaft two cycle sinusoidal cam.

6. The bendah rotary cycle internal combustion engine and air compressor in accordance with claim 1, wherein said means for oscillating piston cylinder wedge to accommodate changing combustion chamber size in four cycle engine comprises a rotates at half the speed of rotor cylinder wedges, one rotation provides for two cycles of oscillation of piston cylinder wedge, integral with driveshaft four cycle sinusoidal cam.

7. The bendah rotary cycle internal combustion engine and air compressor in accordance with claim 1, wherein said means for enhancing the performance of the combustion chamber beneath valves and spark plug comprises a bevel.

8. The bendah rotary cycle internal combustion engine and air compressor in accordance with claim 1, wherein said means for attaching to rotor to form balanced rotor cylinder wedge comprises a pocketed on large side, aluminum, with threaded holes wedge portion.

9. The bendah rotary cycle internal combustion engine and air compressor in accordance with claim 1, wherein said means for attaching to wedge portion to form balanced rotor cylinder wedge comprises a steel, pocketed on one side, with holes for screws rotor portion.

10. The bendah rotary cycle internal combustion engine and air compressor in accordance with claim 1, wherein said means for producing a rotationally balanced rotor cylinder wedge comprises a pocket.

11. A bendah rotary cycle internal combustion engine and air compressor for the efficient burning of fuel to produce work energy in the form of an internal combustion engine and, to efficiently compress air in the form of an air compressor, and to efficiently produce work energy from compressed air in the form of a compressed air motor, comprising:
a has angled wedge surface towards combustion chamber, has oil ring, has two compression rings, connected to another piston cylinder wedge of opposite direction, hollow pocketed to be lightweight piston cylinder wedge, for oscillating to accommodate changes in size to the combustion chamber by the rotor cylinder wedge;
a has angled surface towards combustion chamber, light wedge portion and heavy rotor portion, hollow on large side, rotationally balanced rotor cylinder wedge, for rotating to provide suction intake when intake valve is open, rotating to provide compression of air/fuel mixture when intake valve and exhaust valve is closed, rotating in response to expanding gas from combustion cycle mixture ignited, and rotating to push exhaust out of chamber when exhaust valve is open;
a for two stroke operation, has two compression rings stationary piston, for compressing air/fuel mixture into combustion chamber for two cycle engine operation, internally placed to said piston cylinder wedge;
an one rotation provides for one cycle of oscillation of piston cylinder wedge, revolves at same speed as rotor cylinder wedge, integral with driveshaft two cycle sinusoidal cam, for oscillating piston cylinder wedge to accommodate changing combustion chamber size in two cycle engine or air compressor, reciprocally coupled to said piston cylinder wedge;
a rotates at half the speed of rotor cylinder wedges, one rotation provides for two cycles of oscillation of piston cylinder wedge, integral with driveshaft four cycle sinusoidal cam, for oscillating piston cylinder wedge to accommodate changing combustion chamber size in four cycle engine, reciprocally coupled to said piston cylinder wedge;
a bevel, for enhancing the performance of the combustion chamber beneath valves and spark plug;
a pocketed on large side, aluminum, with threaded holes wedge portion, for attaching to rotor to form balanced rotor cylinder wedge;
a steel, pocketed on one side, with holes for screws rotor portion, for attaching to wedge portion to form balanced rotor cylinder wedge, rigidly fastened to said wedge portion; and
a pocket, for producing a rotationally balanced rotor cylinder wedge.

12. A bendah rotary cycle internal combustion engine and air compressor for the efficient burning of fuel to produce work energy in the form of an internal combustion engine and, to efficiently compress air in the form of an air compressor, and to efficiently produce work energy from compressed air in the form of a compressed air motor, comprising:
a has angled wedge surface towards combustion chamber, has oil ring, has two compression rings, connected to another piston cylinder wedge of opposite direction, hollow pocketed to be lightweight piston cylinder wedge, for oscillating to accommodate changes in size to the combustion chamber by the rotor cylinder wedge;
a has angled surface towards combustion chamber, light wedge portion and heavy rotor portion, hollow on large side, rotationally balanced rotor cylinder wedge, for rotating to provide suction intake when intake valve is open, rotating to provide compression of air/fuel mixture when intake valve and exhaust valve is closed, rotating in response to expanding gas from combustion cycle mixture ignited, and rotating to push exhaust out of chamber when exhaust valve is open;
a for two stroke operation, has two compression rings stationary piston, for compressing air/fuel mixture into combustion chamber for two cycle engine operation, internally placed to said piston cylinder wedge;
an one rotation provides for one cycle of oscillation of piston cylinder wedge, revolves at same speed as rotor cylinder wedge, integral with driveshaft two cycle sinusoidal cam, for oscillating piston cylinder wedge to accommodate changing combustion chamber size in two cycle engine or air compressor, reciprocally coupled to said piston cylinder wedge;
a rotates at half the speed of rotor cylinder wedges, one rotation provides for two cycles of oscillation of piston cylinder wedge, integral with driveshaft four cycle sinusoidal cam, for oscillating piston cylinder wedge to accommodate changing combustion chamber size in four cycle engine, reciprocally coupled to said piston cylinder wedge;
a bevel, for enhancing the performance of the combustion chamber beneath valves and spark plug;
a pocketed on large side, aluminum, with threaded holes wedge portion, for attaching to rotor to form balanced rotor cylinder wedge;
a steel, pocketed on one side, with holes for screws rotor portion, for attaching to wedge portion to form balanced rotor cylinder wedge, rigidly fastened to said wedge portion; and
a pocket, for producing a rotationally balanced rotor cylinder wedge.
